(19) United States
(12) Patent Application Publication
(10) Pub. No.: US 2025/0131846 A1
(43) Pub. Date: Apr. 24, 2025

(54) REMOTE NON-DESTRUCTIVE TESTING & TRAINING SYSTEM, PROCESS AND PLATFORM FOR "HANDS-ON" NDT APPLICATIONS

(71) Applicant: Glenn Malbrue, Carencro, LA (US)

(72) Inventor: Glenn Malbrue, Carencro, LA (US)

(21) Appl. No.: 18/491,117

(22) Filed: Oct. 20, 2023

(51) Int. Cl. G09B 7/02; G01N 29/30

(52) U.S. Cl. CPC G09B 7/02; G01N 29/30

(57) ABSTRACT

A remote non-destructive practical applications testing and training system, method and platform is disclosed. The system, method and platform includes an administrator module, a test module, a test viewer module, a sample manager module, and a live viewer module. The administrator module allows for the addition and editing of candidate information within the system, method, and platform. The test module generates tests for candidates using each candidate's candidate ID, testing profile, and test samples stored within the system, method, and platform. The test module also stores the tests and test results in a manner that allows candidates and trainers to review the tests after the tests are submitted. The sample manager module allows for test samples to be added to or edited on the platform, system, and method. The live viewer module allows users to conduct remote training with augmented reality overlaid on video communications to enhance training.

### BACKGROUND OF THE INVENTION

The present invention relates to Nondestructive Testing (NDT) practical or “hands-on” training systems and, more particularly, to a remote hands-on training system, process, and platform for deployment.

The modern world relies on safe and reliable infrastructure and systems to provide all the comforts and tools of modern life, including power, transportation, storage, materials, among many others. It is imperative that such infrastructure and systems remain operational on a consistent and long-term basis with minimal disruption to their operation. Thus, proper and timely maintenance must be done. However, maintenance can be disruptive and there may be situations where it may be unnecessary to perform maintenance, wasting money and time.

One way to ensure that maintenance is necessary and that disruption is minimized is to perform non-destructive testing (NDT). NDT is performed by technicians who are certified to perform specific non-destructive tests. To be certified, the technicians must take a certification examination(s) after receiving formal training and on-the-job/hands-on training. This on-the-job training is typically done in person and requires significant amounts of time and money, with much of that time and money being spent on traveling to and from training sites. While some remote training options are available and ease some of the travel and associated expenses, such conventional remote training does not provide practical hands-on experience. Further conventional training options have large amounts of downtime and use training personnel inefficiently.

As can be seen, there is a need for remote NDT hands-on applications training & competency testing that provides the flexibility of remote training but still maintains the benefits of a practical hands-on experience provided by in-person training. The present invention solves these issues by providing a remote training system, method, and platform for non-destructive testing hands-on applications training, with metrics to monitor growth and workforce readiness prior to group deployment to Industry Sector Examinations such as the American Society of Non-Destructive Testing's ISQ UTT exam. The present invention eliminates the inefficiencies of the prior art, better utilizing personnel and integrating remote training options into trainers' and trainees' existing workflows.

### SUMMARY OF THE INVENTION

In one aspect of the present invention, a system and platform is provided for non-destructive testing practical training. The system and platform comprises at least one server having an internet connection and storing a plurality of instructions comprising a user dashboard, a history module, an administrator module, a test module, a test viewer module, a sample manager module, a sample data module, and a live viewer module; wherein the administrator module causes the system to receive, via the internet connection, candidate information, and generate a candidate ID based upon the candidate information; wherein the test module allows a candidate to input his/her data from the practical examinations that they have carried out on known samples that are in the system to generate, receive test input from a user, analyze the test input, and generate a test grade based upon the test input; wherein the test viewer module causes the system to display tests; wherein the sample manager module causes the system to receive sample inputs and generate test samples based upon the sample inputs; and wherein the live viewer module causes the system to receive video and audio inputs from a first user device and relay the video and audio inputs to a second user device, with the first and second user devices communicating via an internet connection that passes through the at least one server. Augmented and virtual reality simulation of known samples in an AR environment with live communication from an instructor may be used as part of the Live Viewer module.

In another aspect of the present invention, the test module further causes the system to archive the test grade, test input, and test sample for subsequent review by the user.

In another aspect of the present invention, the administrator view allows for candidate management. A user is added by inputting First Name, Last Name, Username, Email, Password, and Company.

In another aspect of the present invention, the live viewer module causes the system to generate and display an augmented reality overlay on at least the video inputs relayed to the second user device.

In another aspect of the present invention, a method is provided for non-destructive testing training. The method comprises the steps of receiving, by at least one server having an internet connection and comprising at least one processor executing a plurality of instructions within a memory, candidate information; generating a candidate ID based upon the candidate information; generating a testing profile tied to the candidate ID; receiving test samples and test data, and storing the test samples and test data on the at least one server; generating tests based upon the test samples and test data, and tying the test to the testing profile; receiving test inputs for at least one of the generated tests; analyzing the test inputs; generating a test grade based upon the test inputs; archiving the test input and test sample on the at least one server; updating the test samples and test data based upon sample inputs received by the at least one server after initial reception of the test samples and test data; and receiving video and audio inputs from a first user device, and displaying the video and audio inputs from the first user device on a user interface of a second user device.

In another aspect of the present invention, the method further comprises the step of displaying at least one of a test grade, test input, and test sample upon user selection of a stored test grade, test input, and test sample, respectively.

In another aspect of the present invention, the method further comprises the step of the candidate information including at least a candidate name and a candidate phone number.

In another aspect of the present invention, the method further comprises the step of generating a Candidate ID based upon the candidate phone number and the first two letters the candidate name.

In another aspect of the present invention, the method further comprises the step of generating and displaying an augmented reality overlay on at least the video inputs relayed to the second user device, such that a first user of the first user device may provide oral and visual instruction to a second user of the first user device utilizing the augmented reality overlay.

These and other features, aspects and advantages of the present invention will become better understood with reference to the following drawings, description, and claims.

### BRIEF DESCRIPTION OF THE DRAWINGS

FIG. 1 shows a schematic diagram of a system in accordance with an embodiment of the present invention;

FIG. 2 shows a user dashboard interface in accordance with an embodiment of the present invention;

FIG. 3 shows a history module interface in accordance with an embodiment of the present invention;

FIG. 4 shows an administrator module interface in accordance with an embodiment of the present invention;

FIG. 5 shows a group management function interface of the administrator module in accordance with an embodiment of the present invention;

FIG. 6 shows a sample date module interface in accordance with an embodiment of the present invention;

FIG. 7 shows a sample manager module interface in accordance with an embodiment of the present invention; and

FIG. 8 shows a test viewer module interface in accordance with an embodiment of the present invention.

### DETAILED DESCRIPTION OF THE INVENTION

The techniques of the present disclosure are illustrated as being implemented in a computing device such as a PC, laptop, tablet, smartphone or other device capable of executing computer-executed instructions stored on a non-transient medium, e.g., memory, such as RAM, ROM, EPROM, flash memory and so on. Thus, the execution of steps in a process flow is by way of computer-execution of such steps, e.g., via a processor configured to retrieve the corresponding instructions from memory and execute them.

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a remote training system, method, and platform for non-destructive testing certification with hands-on applications training. The platform, system, and method of the present invention may include at least one computer with access provided thereto by a user interface. The computer may include at least one processing unit coupled to a form of memory. The computer may include, but is not limited to, a microprocessor, a server, a desktop, laptop, and smart device, such as, a tablet and smart phone. The computer includes a program product including a machine-readable program code for causing, when executed, the computer to perform steps. The program product may include systemic software which may either be loaded onto the computer or accessed by the computer. The loaded systemic software may include an application on a smart device. The systemic software may be accessed by the computer using a web browser. The computer may access the systemic software in part or entirely via the web browser using the internet, extranet, intranet, host server, internet cloud and the like.

The platform, system, and method may further comprise a administrator module, a test module, a test viewer module, a sample manager module, and a live viewer module. The administrator module may include an administrative function that allows for the addition and editing of candidate information manually by trainers or automatically by the platform and system. The test module includes an archiving function within a history module tied to candidate information entered into the administrator module. The test module uses the candidate information to create a testing profile for each candidate. The test module then allows each candidate to take and submit tests, with the test module saving submitted tests to the appropriate testing profile using the archiving function within the history module. The test viewer module allows both trainers and candidates to review candidates' tests, thereby allowing trainers to better understand a candidates' understanding of NDT techniques and practical principles. The sample manager module allows for new testing samples to be added to the platform, system, and method, while further allowing existing samples in the platform, system, and method to be updated and edited. The live viewer module provides users, both trainers and candidates, the ability to conduct remote hands-on application training, thus providing instantaneous communication and feedback between trainers and candidates.

The present invention thus provides an efficient and flexible platform, system, and method with which candidates may better train for certification in NDT. The present invention provides instantaneous feedback along with hands-on practical training that better prepares candidates for NDT certification tests.

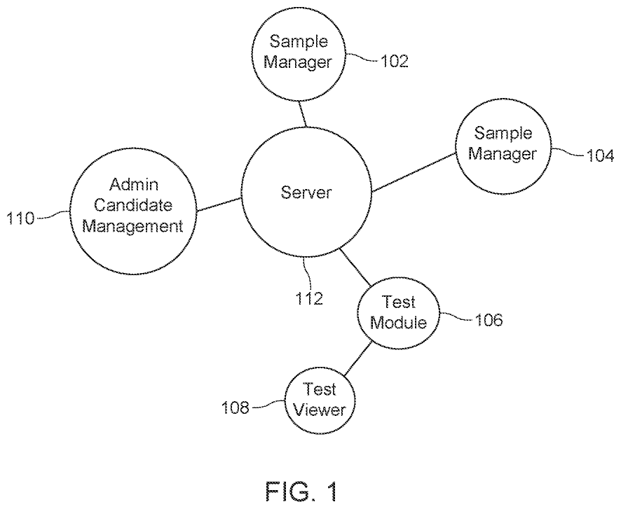

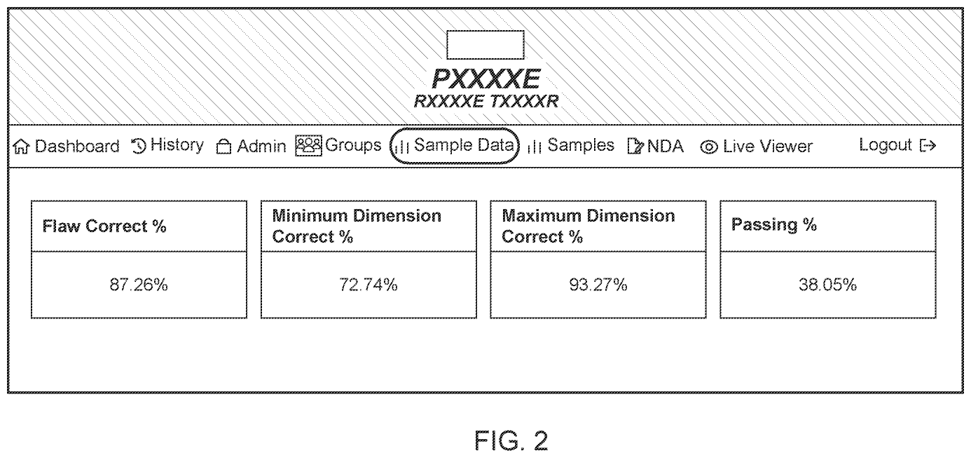

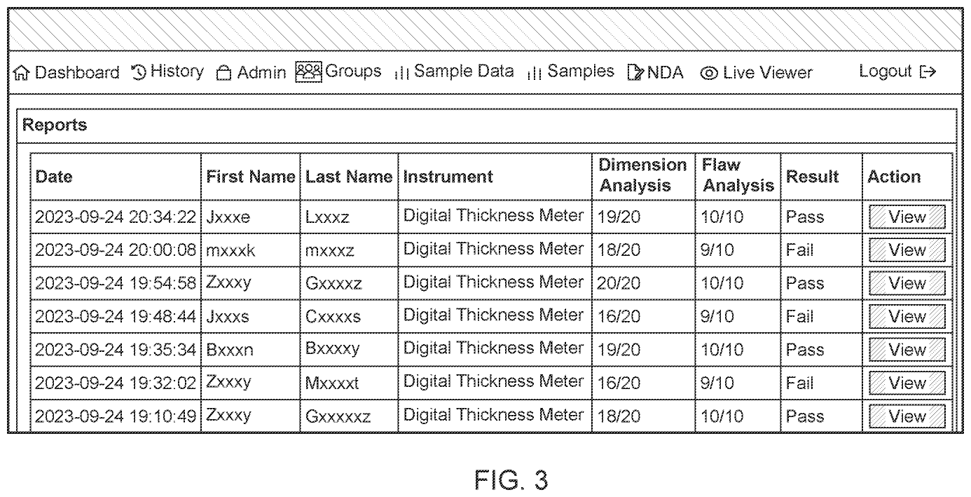

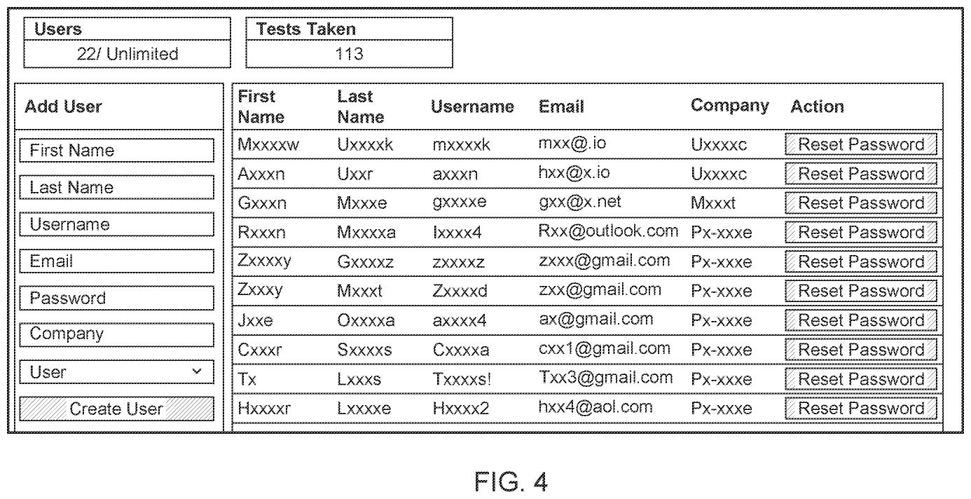

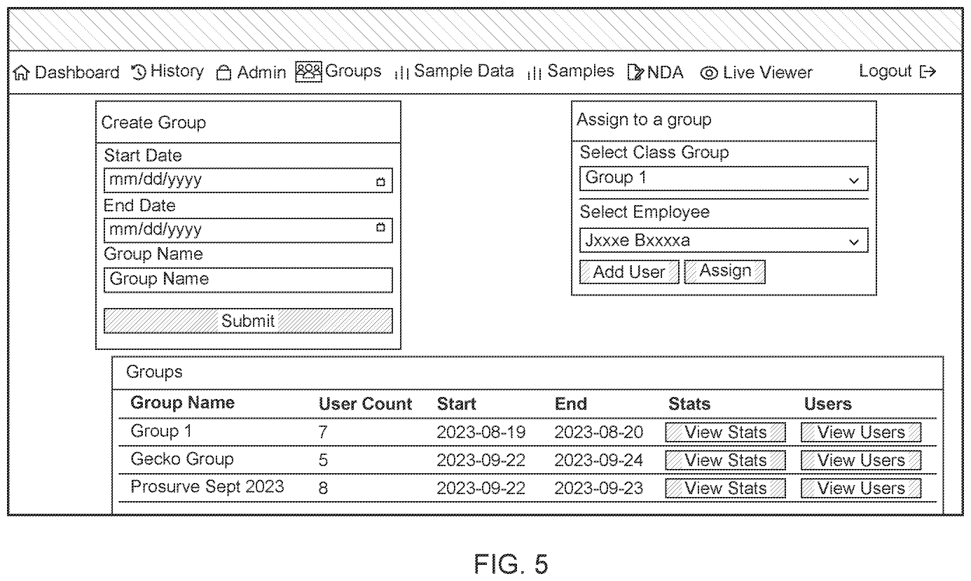

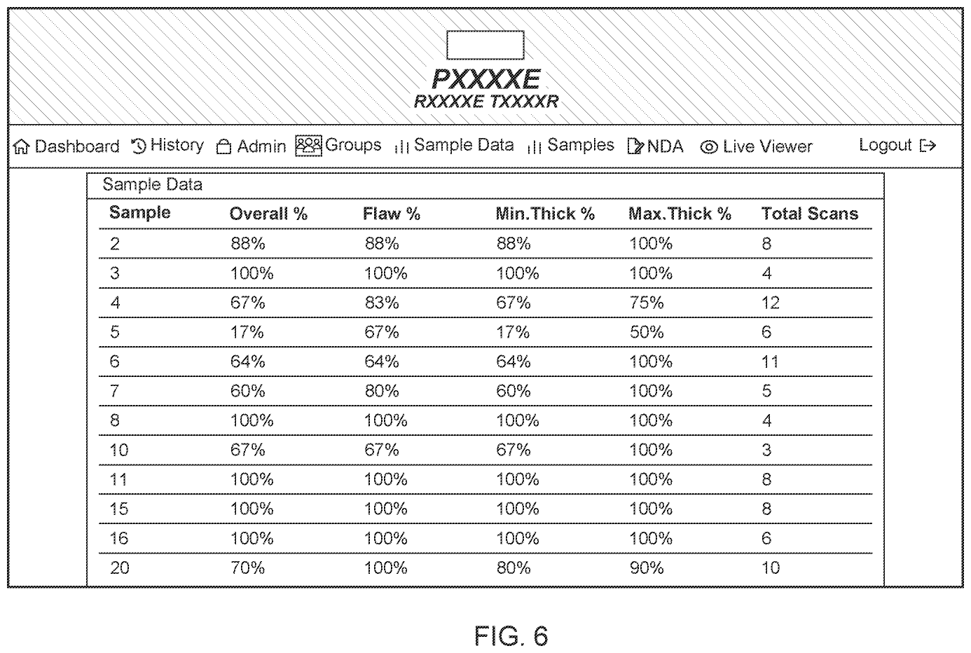

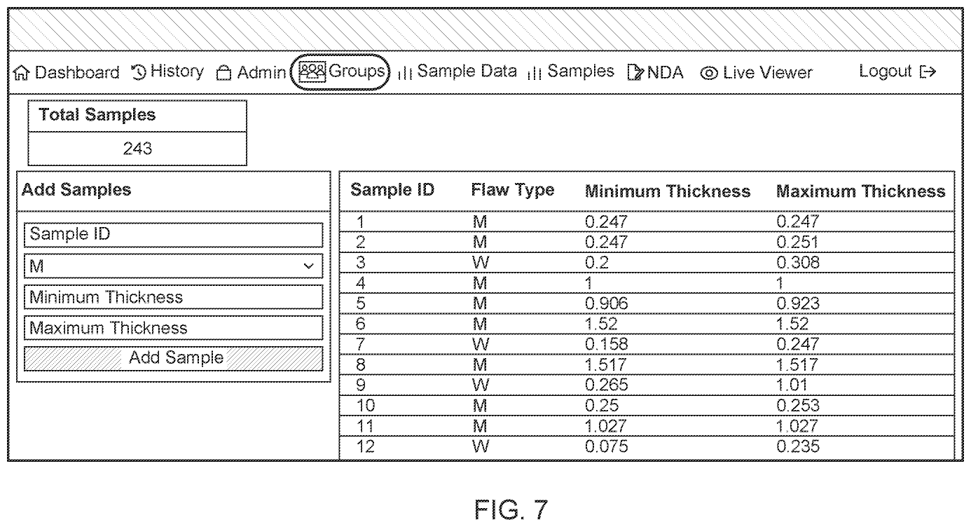

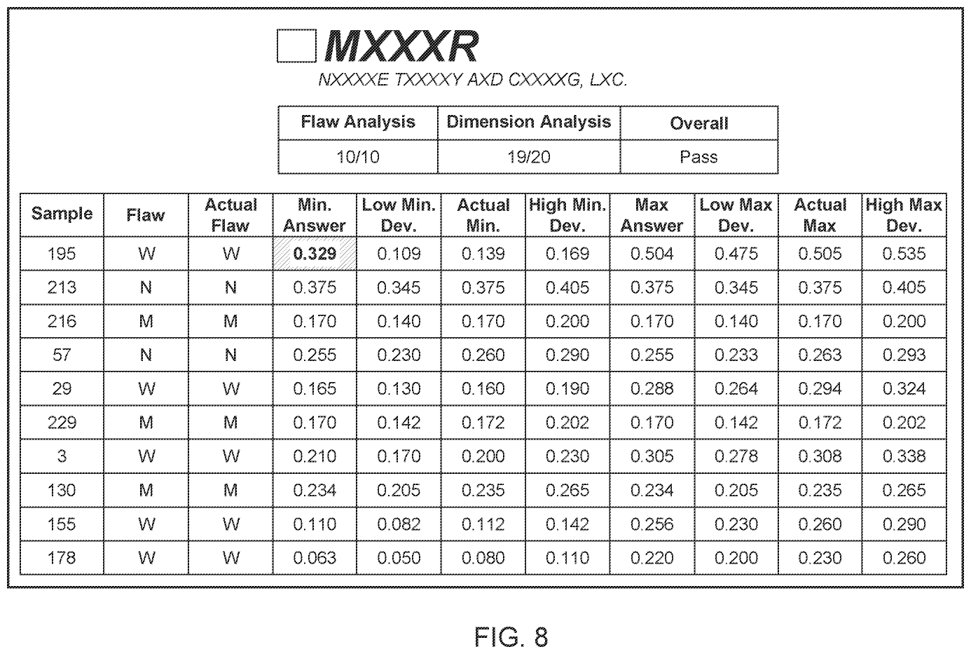

Referring to FIGS. 1-8, an embodiment of a remote hands-on applications training platform, system, and method in accordance with the present invention is provided. The platform, system, and method comprise at least one server 112 housing the information and instructions needed to execute the platform, system, and method of the present invention. A user, such as a candidate or trainer, may access the at least one server 112 via a local device, such as a smartphone or computer, via a hardwired or wireless internet connection. The local device may use a web browser or downloaded application to establish the internet connection between the local device and the at least one server 112. Upon accessing the at least one server 112, the platform, system, and method of the present invention provide the user with a log-in interface through which the user may register with the platform, system, or method or log-in to the platform, system, and method using account information, e.g., username and password, that the user previously generated using the platform, system, and method.

Once logged in, the platform, system, and method display a selection screen to the user. The selection screen allows the user to select and use at least one system module or to exit the platform, system, and method of the present invention. As best seen in FIG. 1, the system, platform, and method of the present invention comprises at least an administrator module 110, a test module 106, a test viewer module 108, a sample manager module 102, 104, and a live viewer module. The system, platform, and method of the present invention may further include a limiting function to limit access of certain functions based upon a user's status as a candidate or trainer.

The administrator module allows a user to add or edit candidate information automatically, e.g., as information is entered during the registration process, or manually, e.g., a user selects the administrator module and enters the information. Candidate information may include personal information or identification information related to a particular candidate. For example, the candidate information may include a candidate's name, company, email and phone information. The administrator module may include an administrative function that allows users to add and edit candidate information. In some embodiments, the administrator module limits access for users such that a user may only edit the user's own candidate information, e.g., if the user is a candidate, or a select group of candidates' information, e.g., if the user is a trainer with a set number of candidates they are training through the system, platform, and method of the present invention. Further, the administrator module includes a Candidate ID creation function that provides for the automatic or manual creation of a unique Candidate ID for each candidate using the platform, system, and method of the present invention. The candidate ID creation function may create a Candidate ID using candidate information entered into the system. For example, the Candidate ID creation function may use at least a portion of a phone number and letters from a candidate's first or last name to create a unique Candidate ID.

Once a Candidate ID is created, the test module 106 uses the Candidate ID to generate a testing profile for each candidate. The test module 106 then provides each candidate with the ability to take and review tests that prepare a candidate for NDT certification testing. When taking tests, the test module 106 presents candidates with samples that the candidate must do non-destructive testing on. The test module 106 also provides an input space in which candidates may input test answers for each sample. The test answers may include measurements and data taken from the sample by candidates, flaw types associated with the sample, and the minimum and maximum thicknesses associated with the sample. After inputting the test answers, the candidate may select a submit button and the test module 106 then automatically grades the candidates test answers.

The test module 106 further includes an archiving function within a history module tied to the Candidate ID. The archiving function allows the test module 106 to store each test and tie each test to the Candidate ID so that only the candidate linked to the Candidate ID and their assigned trainer may view and review individual tests previously taken by the candidate within the history module on the platform, system, and method of the present invention. The test module 106 may also store real-time training feedback from the live viewer module. The test module 106 may thus also be used to review real-time feedback provided by trainers to candidates during a training session when the candidate and trainer used the live viewer module.

The test viewer module 108 allows both trainers and candidates to review a candidate's tests and training feedback for all completed tests and training taken by the candidate. The test viewer module 108 thus provides a holistic view of a candidates progress in understanding NDT techniques and principles that the trainers can then use to better guide a candidate's training and testing going forward. The test viewer module 108 further provides each trainer with the ability to view all tests and training feedback for every candidate assigned to the trainer. This allows the trainer to see how all of their candidates are performing and if adjustments in training need to be made by the trainer to help more candidates succeed. The test viewer module 108 also provides candidates and trainers with a PDF document creation function so that printouts of tests and training feedback may be created for selected tests and training feedback.

The sample manager module 102, 104 cooperates with the test module 106 and to allow trainers to add or edit samples being used in tests to be added to the platform, system, and method of the present invention. Further, the sample manager module 102, 104 provides trainers with edit and update functions such that trainers may edit or update existing testing samples to provide better training results to candidates. For example, if a testing sample is found to be confusing for candidates, the trainer may edit the testing sample so that candidates are able to better understand NDT techniques and principles. Alternatively, if new NDT techniques are established, testing samples may be edited or updated to allow candidates to practice with the new techniques and thereby be better prepared for NDT certification tests.

The live viewer module provides users, both trainers and candidates, the ability to conduct remote testing & training, thus providing instantaneous communication and feedback between trainers and candidates. The live viewer module may utilize a local device's camera, microphone, or both to allow trainers and candidates to view and hear one another through a video displayed via the platform and on a user interface of respective local devices. The live viewer module may also include an augmented reality (AR) function to allow trainers to help candidates better visualize how to apply NDT techniques and principles and conduct NDT testing. For example, trainers may utilize the AR function to show how defects in infrastructure components may appear or how testing tools may be applied to infrastructure components to conduct NDT testing.

The present invention thus allows NDT service providers to effectively provide pre-requisite hands-on training and pre-testing ahead of actual standardized practical NDT certification testing. This enables NDT service providers to place their personnel into tiers for training needs. For example, if an NDT service provider requires personnel certified to ASNT's ISQ Ultrasonic Thickness (ISQ-UTT), the NDT service provider is able to use the present invention to determine which personnel need more training to become certified and when. The present invention thereby allows NDT service providers to better allocate training resources, saving money and time for their business and their employees. The present invention decreases downtime for NDT candidates and trainers and allows training to be built into trainers and candidates existing work weeks.

The computer-based information security prioritization platform, system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for providing hands-on non-destructive testing training & testing, the system comprising:
at least one server having an internet connection and storing a plurality of instructions comprising an administrator module, a test module, a test viewer module, a sample manager module, and a live viewer module;
wherein the administrator module causes the system to receive, via the internet connection, candidate information, and generate a candidate ID based upon the candidate information;
wherein the test module causes the system to generate tests from a plurality of test samples, receive test input from a user, analyze the test input, and generate a test grade based upon the test input;
wherein the test viewer module causes the system to display selected groups of tests;
wherein the sample manager module causes the system to receive sample inputs and generate test samples based upon the sample inputs; and
wherein the live viewer module causes the system to receive video and audio inputs from a first user device and relay the video and audio inputs to a second user device, with the first and second user devices communicating via an internet connection that passes through the at least one server.

2. The system of claim 1, wherein the test module further causes the system to archive the test grade, test input, and test sample for subsequent review by the user.

3. The system of claim 1, wherein the candidate information includes at least a candidate name and a candidate phone number.

4. The system of claim 3, wherein the administrator module causes the system to generate a Candidate ID based upon the candidate phone number and the first two letters the candidate name.

5. The system of claim 1, wherein the live viewer module causes the system to generate and display an augmented reality overlay on at least the video inputs relayed to the second user device.

6. A method for providing non-destructive testing training, the method comprising:
receiving, by at least one server having an internet connection and comprising at least one processor executing a plurality of instructions within a memory, candidate information,
generating a candidate ID based upon the candidate information;
generating a testing profile tied to the candidate ID;
receiving test samples and test data, and storing the test samples and test data on the at least one server;
generating tests based upon the test samples and test data, and tying the test to the testing profile;
receiving test inputs for at least one of the generated tests;
analyzing the test inputs;
generating a test grade based upon the test inputs;
archiving the test input and test sample on the at least one server;
updating the test samples and test data based upon sample inputs received by the at least one server after initial reception of the test samples and test data; and
receiving video and audio inputs from a first user device, and displaying the video and audio inputs from the first user device on a user interface of a second user device.

7. The method of claim 1, further comprising displaying at least one of a test grade, test input, and test sample upon user selection of a stored test grade, test input, and test sample, respectively.

8. The method of claim 1, wherein the candidate information includes at least a candidate name and a candidate phone number.

9. The method of claim 3, further comprising generating a Candidate ID based upon the candidate phone number and the first two letters the candidate name.

10. The method of claim 1, further comprising generating and displaying an augmented reality overlay on at least the video inputs relayed to the second user device, such that a first user of the first user device may provide oral and visual instruction to a second user of the first user device utilizing the augmented reality overlay.
